(19) United States
(12) Patent Application Publication
(10) Pub. No.: US 2024/0350243 A1
(43) Pub. Date: Oct. 24, 2024

(54) DENTAL PROPHY ANGLE

(71) Applicant: Jinhui Tan, Dongguan, Guangdong (CN)

(72) Inventor: Jinhui Tan, Dongguan, Guangdong (CN)

(21) Appl. No.: 18/027,367

(22) PCT Filed: Jul. 21, 2022
(86) PCT No.: PCT/CN2022/106997

§ 371 Date: Mar. 20, 2023

(30) Foreign Application Priority Data
Dec. 29, 2021 (CN) 202123360384.2

(51) Int. Cl. A61C 17/00; A61C 1/12; A61C 1/18

(52) U.S. Cl. CPC A61C 17/005; A61C 1/12; A61C 1/185

(57) ABSTRACT

A dental prophy angle includes a housing, a driving assembly, a first limiting member, a second limiting member, and a prophy cup, where the driving assembly includes a first driving shaft and a second driving shaft; the second driving shaft comprises one end connected to the first driving shaft by a gearing connection, and the other end provided with the prophy cup; and the first limiting member is sleeved on the first driving shaft and locates between the first driving shaft and an inner wall of the housing, and the second limiting member is sleeved on the second driving shaft and locates between the second driving shaft and the inner wall of the housing, to play a position limiting role and prevent the first driving shaft from falling out. The first limiting member is in snap connection with the housing for fixation, which makes the installation simple.

### TECHNICAL FIELD

The present disclosure relates to a dental prophy angle, and belongs to a technical field of medical devices.

### BACKGROUND

As a basic medical device in the department of stomatology, the dental prophy angle provides low-speed rotation for a prophy cup thereon for teeth cleaning and polishing. It is used with a dental irrigator and directly penetrates into the oral cavity to reach any corner. The prophy angle in the prior art is mostly glued or bolted, with cumbersome assembly.

### SUMMARY

In view of the problems in the prior art, an objective of the present disclosure is to provide a dental prophy angle, which has simpler installation, less accessories and lower production cost by reasonably optimizing a structure and employing a plurality of limiting structures.

In order to achieve the above objective, the present disclosure adopts the following technical solutions:

A dental prophy angle includes a housing, a driving assembly, a first limiting member, a second limiting member, and a prophy cup, where the driving assembly includes a first driving shaft and a second driving shaft; the second driving shaft includes one end connected to the first driving shaft by a gearing connection, and the other end provided with the prophy cup; a gearing connection position between the first driving shaft and the second driving shaft are respectively provided with a first gear and a second gear; the first limiting member is sleeved between the first driving shaft and an inner wall of the housing; and the second limiting member is sleeved between the second driving shaft and the inner wall of the housing.

Preferably, the inner wall of the housing forms a first mounting chamber for holding the first driving shaft and a second mounting chamber for holding the second driving shaft; the first mounting chamber includes a first limiting segment and a second limiting segment; and the first limiting member is located in the second limiting segment. The first limiting segment and the second limiting segment prevent the first driving shaft from falling out, and further play a position limiting role to prevent the first driving shaft from shaking to cause a displacement.

Preferably, an end of the first limiting segment close to the second mounting chamber is provided with a boss. The boss plays a position limiting role.

Preferably, a limiting groove is provided on the second limiting segment; and a limiting boss is provided on the first limiting member. Upon assembly, the limiting boss snaps into the limiting groove to play a position locating role.

Preferably, a first limiting ring and a second limiting ring are provided on the first driving shaft; and upon assembly, the first limiting ring and the second limiting ring are respectively located at two ends of the first limiting segment. The first limiting ring abuts against the boss to play a position limiting role, and the second limiting ring abuts against the first limiting member to play a position limiting role. With position limitation at the two ends of the first limiting segment, a higher stability is achieved.

Preferably, the first gear and the second gear are bevel gears engaged to each other, and are located in the second mounting groove. The bevel gears are engaged to each other, which effectively prevents the second driving shaft from falling out.

The present disclosure achieves the following beneficial effects over the prior art: The conventional bolted connection is abandoned, and the first limiting member is in a snap connection with the housing for fixation, which makes the installation simple. The first driving shaft and the second driving shaft are engaged to each other with the bevel gears, which not only realizes a driving effect, but also plays a position limiting role through the gear structure to prevent the second driving shaft from falling out. In this way, less installation accessories are used for fixation, and the production cost is lower. Therefore, the present disclosure achieves desirable promotion value and application prospect.

### BRIEF DESCRIPTION OF THE DRAWINGS

FIG. 1 is a schematic structural view of a dental prophy angle according to a preferred embodiment of the present disclosure;

FIG. 2 is a schematic sectional view of a dental prophy angle according to a preferred embodiment of the present disclosure;

FIG. 3 is a schematic exploded view of a dental prophy angle according to the present disclosure;

### DETAILED DESCRIPTION

The present disclosure is further described below in detail with reference to the accompanying drawings and preferred embodiments.

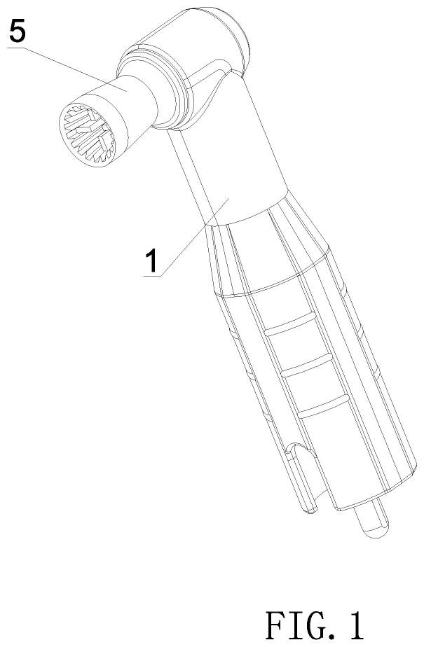

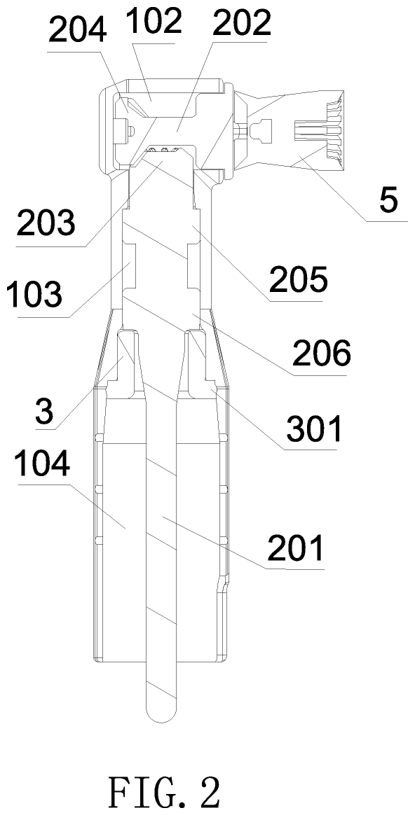

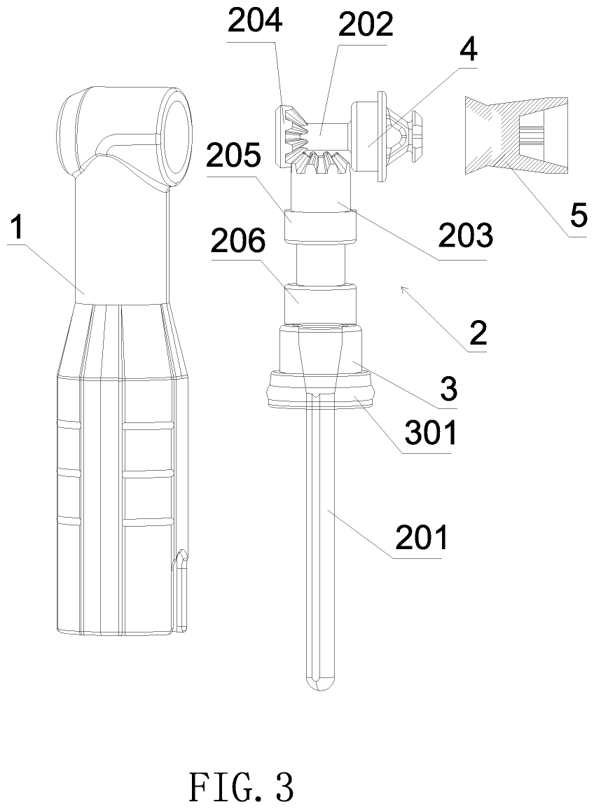

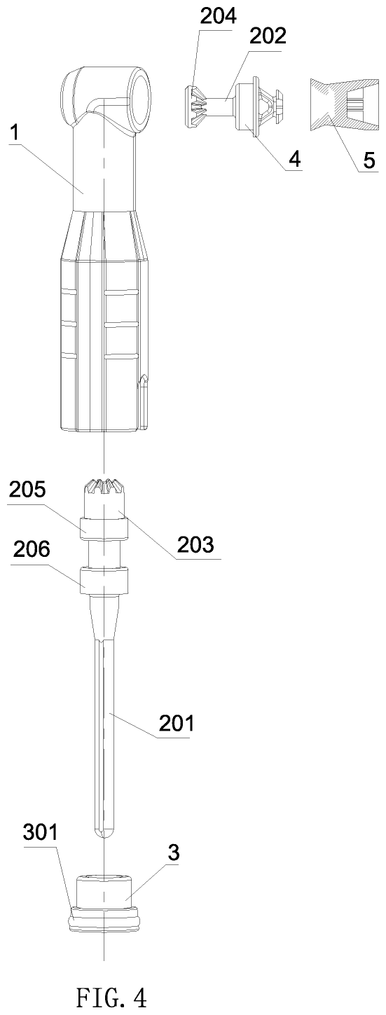

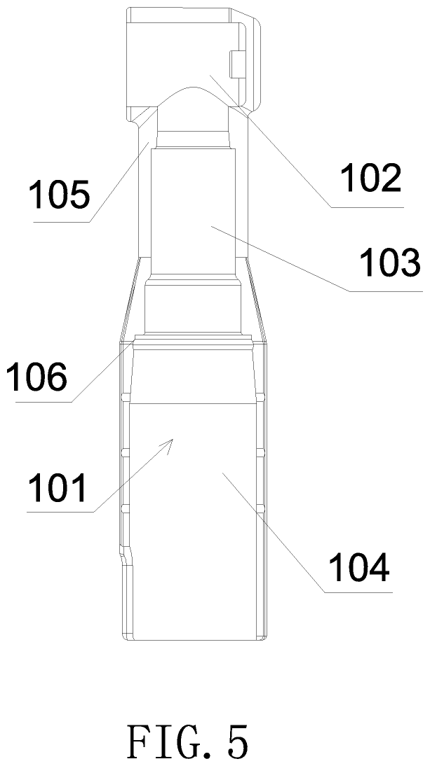

FIGS. 1-3 each are a schematic view of a dental prophy angle according to a preferred embodiment of the present disclosure. As shown in FIGS. 1-3, the dental prophy angle includes a housing 1, a driving assembly 2, a first limiting member 3, a second limiting member 4, and a prophy cup 5. The driving assembly 2 includes a first driving shaft 201 and a second driving shaft 202. The second driving shaft 202 includes one end connected to the first driving shaft 201 by a gearing connection, and the other end provided with the prophy cup 5. A gear connection position between the first driving shaft 201 and the second driving shaft 202 are respectively provided with a first gear 203 and a second gear 204. The first limiting member 3 is sleeved between the first driving shaft 201 and an inner wall of the housing 1. The second limiting member 4 is sleeved between the second driving shaft 202 and the inner wall of the housing 1. The inner wall of the housing 1 forms a first mounting chamber 101 for holding the first driving shaft 201 and a second mounting chamber 102 for holding the second driving shaft 202. The first mounting chamber 101 includes a first limiting segment 103 and a second limiting segment 104. The first limiting member 3 is located in the second limiting segment 104. An end of the first limiting segment 103 close to the second mounting chamber 102 is provided with a boss 105. A limiting groove 106 is provided on the second limiting segment 104. A limiting boss 301 corresponding to the limiting groove 106 is provided on the first limiting member 3. A first limiting ring 205 and a second limiting ring 206 are provided on the first driving shaft 201. Upon assembly, the first limiting ring 205 and the second limiting ring 206 are respectively located at two ends of the first limiting segment 103. The first gear 203 and the second gear 204 are bevel gears engaged to each other, and are located in the second mounting chamber 102. In response to installation, the first driving shaft is inserted into the first mounting chamber. The second driving shaft is inserted into the second mounting chamber. The second limiting member is inserted between the second driving shaft and the housing. The prophy cup is fixed at the end of the second driving shaft. In this process, the first gear and the second gear are engaged with each other. The first limiting ring and the second limiting ring on the first driving shaft are respectively located at the two ends of the first limiting segment. The first limiting ring abuts against the boss on the inner wall of the housing. At last, the first limiting member is inserted between the first driving shaft and the inner wall of the housing, so that the first limiting member abuts against the second limiting ring, and the limiting boss on the first limiting member snaps into the limiting groove, to finish the installation.

The present disclosure achieves the following beneficial effects over the prior art: The conventional bolted connection is abandoned, and the first limiting member is in a snap connection with the housing for fixation, which makes the installation simple. The first driving shaft and the second driving shaft are engaged to each other with the bevel gears, which not only realizes a driving effect, but also plays a position limiting role through the gear structure to prevent the second driving shaft from falling out. In this way, less installation accessories are used for fixation, and the production cost is lower. Therefore, the present disclosure achieves desirable promotion value and application prospect.

The above shows and describes the basic principles, main features, and advantages of the present disclosure. It should be understood by those skilled in the art that, the present disclosure is not limited by the above embodiments, and the above embodiments and the descriptions only illustrate the principle of the present disclosure. Various changes and modifications may be made to the present disclosure without departing from the spirit and scope of the present disclosure, and such changes and modifications all fall within the claimed scope of the present disclosure. The claimed protection scope of the present disclosure is defined by the appended claims and equivalents thereof.

1. A dental prophy angle, comprising a housing, a driving assembly, a first limiting member, a second limiting member, and a prophy cup, wherein the driving assembly comprises a first driving shaft and a second driving shaft; the second driving shaft comprises one end connected to the first driving shaft by a gearing connection, and the other end provided with the prophy cup; a gear connection position between the first driving shaft and the second driving shaft are respectively provided with a first gear on the first driving shaft and a second gear on the second driving shaft; the first gear and the second gear are engaged with each other; the first limiting member is sleeved on the first driving shaft and located between the first driving shaft and an inner wall of the housing; and the second limiting member is sleeved on the second driving shaft and located between the second driving shaft and the inner wall of the housing.

2. The dental prophy angle according to claim 1, wherein the inner wall of the housing forms a first mounting chamber for holding the first driving shaft and a second mounting chamber for holding the second driving shaft; the first mounting chamber comprises a first limiting segment and a second limiting segment; and the first limiting member is located in the second limiting segment.

3. The dental prophy angle according to claim 2, wherein an end of the first limiting segment close to the second mounting chamber is provided with a boss.

4. The dental prophy angle according to claim 2, wherein a limiting groove is provided on the second limiting segment; and a limiting boss corresponding to the limiting groove is provided on the first limiting member.

5. The dental prophy angle according to claim 1, wherein a first limiting ring and a second limiting ring are provided on the first driving shaft; and the first limiting ring and the second limiting ring are respectively located at two ends of the first limiting segment.

6. The dental prophy angle according to claim 1, wherein the first gear and the second gear are bevel gears, and are located in the second mounting chamber.
